(19) United States
(12) Patent Application Publication
(10) Pub. No.: US 2015/0031827 A1
(43) Pub. Date: Jan. 29, 2015

(54) POLYMER, CLATHRATE USING THE POLYMER, AND AQUEOUS DISPERSION OF SHEET OF THE POLYMER

(71) Applicants: Chiyoshi Nozaki, Shizuoka (JP); Chiaki Tanaka, Shizuoka (JP); Taichi Nemoto, Shizuoka (JP)

(72) Inventors: Chiyoshi Nozaki, Shizuoka (JP); Chiaki Tanaka, Shizuoka (JP); Taichi Nemoto, Shizuoka (JP)

(73) Assignee: RICHO COMPANY, LTD., Tokyo (JP)

(21) Appl. No.: 14/198,775

(22) Filed: Mar. 6, 2014

(30) Foreign Application Priority Data
Jul. 26, 2013 (JP) 2013-155571

(51) Int. Cl. C08G 63/08; C08L 67/04

(52) U.S. Cl. CPC C08G 63/08; C08L 67/04
USPC 524/599; 525/54.2

(57) ABSTRACT

A polymer is provided. The polymer includes a polymer chain; and a saccharide bonded with the polymer chain. The polymer does not substantially include an organic solvent and a metal atom, and includes a residual monomer in an amount of not greater than 1,000 ppm, which is relatively small compared to the amount of residual monomer in a polymer prepared by a conventional method. The polymer is preferably used for a clathrate, a sheet, and an aqueous dispersion of the sheet.

### CROSS-REFERENCE TO RELATED APPLICATIONS

This patent application is based on and claims priority pursuant to 35 U.S.C. §119 to Japanese Patent Application No. 2013-155571 filed on Jul. 26, 2013 in the Japan Patent Office, the entire disclosure of which is hereby incorporated by reference herein.

### TECHNICAL FIELD

This disclosure relates to a polymer having a polymer chain bonded to a saccharide. In addition, this disclosure relates to a clathrate using the polymer. Further, this disclosure relates to an aqueous dispersion of a sheet of the polymer.

### BACKGROUND

It is conventionally known that saccharide such as cyclodextrin has such a molecular structure as to form a clathrate by containing another material in a void therein or an aggregate thereof. Such a clathrate is used for medicines. For example, since saccharide containing a medicine can gradually release the medicine in the body, the efficacy of the medicine can be maintained over a long period of time.

In addition, it is conventionally known that by bonding a polymer chain to a saccharide to prepare a polymer, the affinity of the saccharide for another material can be enhanced. For example, by containing a medicine in a saccharide to which a polymer chain such as polylactic acid is bonded, it becomes possible to selectively supply the medicine to a portion of the body, which has good affinity for the polymer chain.

When a polymer chain is bonded to a saccharide, polymerization methods using a metallic catalyst have been conventionally used. For example, JP-1-108-019226-B (i.e., JP-S60-076531-A) discloses a method in which cyclodextrin is reacted with lactide in the presence of tin octanate serving as a metallic catalyst to bond a polylactic acid chain to cyclodextrin.

When a polymer chain is bonded to a saccharide without using a metallic catalyst, a method in which raw materials are heated for a long time at a high temperature to perform polymerization has been used. For example, JP-2005-120263-A discloses a technique such that γ-cyclodextrin and D,L-lactide are mixed, and the mixture was heated for a time of from 24 to 120 hours at 100° C., thereby producing a target compound in a yield of from 8% to 14%.

### SUMMARY

As an aspect of this disclosure, a polymer is provided which includes a polymer chain and a saccharide bonded to the polymer chain and which does not substantially include an organic solvent and a metal atom. The polymer includes a residual monomer in an amount of not greater than 1,000 ppm. The polymer may have a sheet form.

As another aspect of this disclosure, a clathrate is provided which includes the polymer mentioned above and contains another material in such a manner that an ion, an atom or a molecule of the material is contained in a void formed by a molecule or an aggregate of the polymer.

As another aspect of this disclosure, an aqueous dispersion is provided which includes water and a sheet of the polymer mentioned above, which is dispersed in water.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a phase diagram illustrating states of a material when temperature and pressure are changed;

FIG. 2 is a phase diagram illustrating states of a compressible fluid used for producing the polymer according to an embodiment when temperature and pressure are changed;

FIG. 3 is a schematic view illustrating a continuous polymerization system for use in producing the polymer according to an embodiment: and

FIG. 4 is a schematic view illustrating a batch polymerization system for use in producing the polymer according to an embodiment.

### DETAILED DESCRIPTION

When the method disclosed by JP-H08-019226-B (i.e., JP-S60-076531-A) mentioned above is used, tin octanate remains in the resultant product, and therefore use of the product is limited because the product cannot be used for metal-averse applications. Further, when it is attempted to remove tin octanate from the product by using an organic solvent, the organic solvent remains in the product, namely it is difficult to perfectly remove tin octanate from the product.

In such a method as disclosed in JP-2005-120263-A mentioned above, when raw materials are heated for a long period of time at a high temperature to bond a polymer chain to a saccharide, a large amount of monomers are formed by depolymerization and the monomers remain in the product. Since the monomers remaining in the product serve as a hydrolysis catalyst, a problem in that properties of the resultant polymer deteriorate is caused.

The polymer of this disclosure includes a polymer chain and a saccharide bonded to the polymer chain, and does not substantially include an organic solvent and a metal atom. In addition, the polymer includes a residual monomer in an amount of not greater than 1,000 ppm.

Hereinafter, an embodiment of this disclosure will be described. The polymer of this disclosure includes a polymer chain and a saccharide bonded to the polymer chain, and is prepared by subjecting a ring-opening polymerizable monomer to ring-opening polymerization using a compressible fluid, an organic catalyst including no metal atom, and an initiator.

Initially, raw materials such as ring-opening polymerizable monomers used for producing the polymer of this disclosure will be described. In this embodiment, the raw materials are defined as materials used for producing the polymer of this disclosure. Specifically, the raw materials are materials which become constituents of the polymer, and include at least a ring-opening polymerizable monomer and an initiator, and optionally include an additive.

Initially, the ring-opening polymerizable monomer will be described. Depending on the compressible fluid used, ring-opening polymerizable monomers having a carbonyl bond such as ester bond in the ring thereof are preferably used as the ring-opening polymerizable monomer. The carbonyl bond has a high reactivity because the oxygen atom thereof, which has high electronegativity, has a π bond with the carbon atom of the carbonyl bond, and the π bond electrons are attracted by the oxygen atom, thereby negatively polarizing the oxygen atom while positively polarizing the carbon atom. In addition, when carbon dioxide is used as the compressible fluid, the resultant polymer has high affinity for carbon dioxide because the carbonyl bond has a structure similar to the structure of carbon dioxide. In this case, the polymer generated by using the compressible fluid can be well plasticized. Examples of such ring-opening polymerizable monomers having a carbonyl bond include cyclic esters and cyclic carbonates. By using such ring-opening polymerizable monomers, polymers having a polymer chain such as polyester chains and polycarbonate chains, and a carbonyl bond such as ester bond and carbonate bond can be produced.

The cyclic esters for use as the ring-opening polymerizable monomers are not particularly limited, but cyclic dimmers prepared by subjecting at least a L(levo-rotatory)- or D(dextro-rotatory)-compound having the following formula (1) to dehydration condensation are preferably used.

R—C*—H(—OH)(—COOH) (1)

wherein R represents an alkyl group having 1 to 10 carbon atoms, and C* represents an asymmetric carbon atom.

Specific examples of compounds having formula (1) include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among these compounds, enantiomers of lactic acid are preferable because of having a good combination of reactivity and availability.

These cyclic dimmers can be used alone or in combination.

Specific examples of cyclic esters obtained from a material other than the compounds having formula (1) include aliphatic lactones such as β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide, and lactide. Among these compounds, ε-caprolactone is preferable because of having a good combination of reactivity and availability.

Specific examples of the cyclic carbonates include ethylene carbonate and propylene carbonate, but are not limited thereto.

These ring-opening polymerizable monomers can be used alone or in combination.

In this embodiment, saccharide is used as the ring-opening polymerization initiator. In this application, saccharide is defined as materials including a monosaccharide as a constituent, and includes saccharide and derivatives thereof. Specific examples of the saccharide include monosaccharides such as glucose, mannose, galactose, fluctose and deoxyribose; disaccharides such as trehalose, isotrehalose and maltose; oligosaccharides such as fructooligosaccharide; cyclic oligosaccharides such as α-cyclodextrin, β-cyclodextrin and γ-cyclodextrin; and polysaccharides such as starch, cellulose and dextrin.

Specific examples of the derivatives of saccharide include uronic acids such as glucuronic acid; amino acids such as glucosamine; and sugar alcohols such as sorbitol and xylitol.

These materials can be used alone or in combination.

It is preferable that the saccharide itself or the saccharide, which is bonded with a polymer chain, contains molecules of another material therein (i.e., the saccharide itself or the saccharide connected with a polymer chain serves as a clathrate). In this regard, “clathrate” means a material in which an ion, an atom or a molecule of another material is contained in a structure of the material having a clathration ability such as cyclodextrin, and “clathration” means a phenomenon such that such an ion, an atom or a molecule of another material is contained in a structure of a clathrate. In this regard, the manner of clathrate (clathration) is not particularly limited as long as the purpose of the clathrate can be attained (for example, a medicine in the clathrate is transported and gradually released therefrom in the body). One example of clathrate is that a material is contained in a space formed in an aggregate of a saccharide, and another example is that a material is contained in an aggregate or a higher-order structure of a polymer chain bonded with a saccharide. Saccharide forms a clathrate by containing another material therein. Specific examples of such a saccharide include cyclic oligosaccharide such as cyclodextrin (e.g., α-cyclodextrin, β-cyclodextrin and γ-cyclodextrin), but are not limited thereto.

In order to control the hydrophilicity of saccharide, derivatives of saccharide can also be used. Specific examples of such saccharide derivatives include cyclodextrin derivatives such as chemically-modified materials of cyclodextrin, e.g., hydroxypropylated β-cyclodextrin, acetylated β-cyclodextrin, triacetylated β-cyclodextrin, methylated β-cyclodextrin, and monochlorotriazinated β-cyclodextrin, which are available from Cyclochem Co., Ltd. and which have a trade name of CAVASOL; monoaminated cyclodextrin, and monotosylated cyclodextrin, which are available from Tokyo Kasei Kogyo Co., Ltd.; and 2-hydroxypropyl-β-cyclodextrin which is available from JUNSEI CHEMICAL CO., LTD.

In addition, derivatives of the chemically-modified materials of cyclodextrin mentioned above can also be used. Further, multimers (dimers, trimers, tetramers, etc.) of cyclodextrin in which modification groups are bonded with each other using a polyfunctional linking group can also be used.

In this embodiment, initiators other than the above-mentioned saccharide can be used in combination with saccharide. Specific examples thereof include known initiators such as alcohols, e.g., monohydric alcohols such as methanol, ethanol, propanol, butanol, pentanol, hexanol, nonanol, decanol, lauryl alcohol, myristyl alcohol, cetyl alcohol, and steary alcohol; dihydric alcohols such as ethylene glycol, 1,2-propanediol, 1,3-propanediol, 1,3-butanediol, 1,4-butanediol, hexanediol, nonanediol, tetramethylene glycol, and polyethylene glycol; polyhydric alcohols such as glycerol, ribitol, erythritol, and triethanol amine; methyl lactate, and ethyl lactate.

Further, polymers having a residual alcohol group at the end thereof such as polycaprolactonediol, and polytetramethylene glycol can also be used as initiators. By using such an initiator, diblock copolymers, and triblock copolymers can be synthesized.

The added amount of such an initiator is determined based on the target molecular weight of the product (i.e., polymer). For example, the added amount is from 0.05% by mole to 5% by mole, and preferably from 0.2% by mole to 2% by mole, based on the ring-opening polymerizable monomer used. In order to prevent initiation of uneven polymerization, it is preferable to well mix a ring-opening polymerizable monomer and an initiator before the monomer contacts a catalyst.

Next, organic catalysts will be described.

In this embodiment, an organic catalyst is used for ring-opening monomers. In this embodiment, any known organic catalysts can be used as long as the purpose of the product (i.e., polymer) can be attained. However, in order to impart a good combination of safety and stability to the product, organic catalysts including no metal atom are used. Specifically, an organic catalyst, which contributes the ring-opening polymerization reaction of the ring-opening polymerizable monomer used and which, after an active intermediate of the ring-opening polymerizable monomer is formed, is released therefrom and regenerated due to reaction with an alcohol, can be preferably used.

When a ring-opening polymerizable monomer having an ester bond is polymerized, basic compounds are preferably used as the organic catalyst, basic compounds having a nitrogen atom are more preferably used, and basic cyclic compounds having a nitrogen atom are even more preferably used. Specific examples thereof include cyclic monoamines, cyclic diamines (e.g., cyclic diamines having an amidine skeleton), cyclic triamines having a guanidine skeleton, heterocyclic aromatic organic compounds having a nitrogen atom, and N-heterocyclic carbenes. In addition, cationic organic catalysts can also be used for the ring-opening polymerization reaction mentioned above.

Specific examples of the cyclic monoamines include quinuclidine. Specific examples of the cyclic diamines include 1,4-diazabicyclo-[2.2.2]octane (DABCO), and 1,5-diazabicyclo[4.3.0]non-5-ene. Specific examples of the cyclic diamines having an amidine skeleton include 1,8-diazabicyclo[5.4.0]undeca-7-ene (DUB), and diazabicyclononene. Specific examples of the cyclic triamines having a guanidine skeleton include 1,5,7-triazabicyclo[4.4.0]deca-5-ene (TBD), and diphenylguanidine (DPG).

Specific examples of the heterocyclic aromatic organic compounds having a nitrogen atom include N,N-dimethyl-4-aminopyridine (DMAP), 4-pyrrolidinopyridine (PPY), pyrrocholine, imidazole, pyrimidine, and purine. Specific examples of the N-heterocyclic carbenes include 1,3-di-tert-butylimidazole-2-ylidene (ITBU).

Among these, DABSCO, DBU, DPG, TBD, DMAP, PPY and ITBU are preferable because they have little steric hindrance and high nucleophilicity while having such a boiling point as to be easily removed at a reduced pressure.

Among these organic catalysts, for example, DBU is a liquid at room temperature and has a boiling point. When such an organic catalyst is used, most of the organic catalyst can be removed from the resultant polymer by subjecting the resultant polymer to a decompression treatment. Choice of organic catalyst and performance of the removal treatment are determined based on the intended purpose of the resultant polymer.

Although amines are preferably used as the organic catalyst as mentioned above, salts of an amine and an acid can also be used as long as the catalytic activity can be exhibited. Specific examples of such salts include salts of organic calboxylic acids, salts of organic sulfonic acids, salts of organic phosphoric acids, salts of hydrochloric acid, salts of carbonic acid, salts of sulfuric acid, salts of phosphoric acid, and alcohols which can form salts with an amino group by proton dissociation.

Choice of the organic catalyst and the added amount thereof change depending on the combination of the below-mentioned compressible fluid used and the ring-opening polymerizable monomer used, and are not unambiguously determined. However, the added amount of an organic catalyst is preferably from 0.01 moles to 15 moles, more preferably from 0.1 moles to 1 mole, and even more preferably from 0.3 moles to 0.5 moles, based on 100 moles of the ring-opening polymerizable monomer used. When the added amount is less than 0.01 moles, the organic catalyst tends to be deactivated before the polymerization reaction is completed, and therefore the resultant polymer has a molecular weight less than the targeted molecular weight. In contrast, when the added amount is greater than 15 moles, it often becomes difficult to control the polymerization reaction.

Next, additives will be described. As mentioned above, an additive can be optionally used for the ring-opening polymerization. For example, surfactants, antioxidants, stabilizers, ultraviolet absorbents, pigments, colorants, particulate inorganic materials, various kinds of tillers, release agents, plasticizers, etc. can be used as additives. In addition, polymerization terminators can also be used to control termination of reaction or to perform a treatment after termination of reaction.

Surfactants which can be dissolved in the compressible fluid used and which have affinity for the compressible fluid and the ring-opening polymerizable monomer used are preferably used as additives. By using such a surfactant, it becomes possible for the polymerization reaction to evenly proceed, thereby narrowing the molecular weight distribution of the resultant polymer, resulting in obtainment of a particulate polymer. When a surfactant is included in the polymerization system, the surfactant can be added to the compressible fluid or the ring-opening polymerizable monomer used.

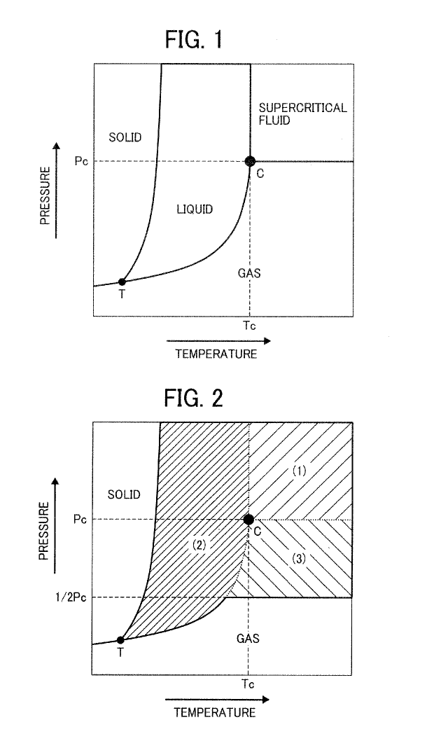

Next, the compressible fluid used for producing the polymer of this disclosure will be described by reference to FIGS. 1 and 2. FIG. 1 is a phase diagram illustrating states of a material when temperature and pressure are changed. FIG. 2 is a phase diagram used for defining a compressible fluid for use in producing the polymer of this disclosure. In this application, the compressible fluid means a material having a state in a region (1), (2) or (3) in FIG. 2.

In the region (1), (2) or (3), the material has a very high density, and exhibits behavior different from that at normal temperatures and pressures. A material in the region (1) is called a supercritical fluid. The supercritical fluid means a fluid which is present as a non-condensable high density fluid in a temperature/pressure region over a critical point C (illustrated in FIGS. 1 and 2) under which both a gas and a liquid of the material can exist and which is not condensed even when being compressed. A material in the region (2) is a liquid. In this embodiment, the material in the region (2) means a liquefied gas obtained by compressing a material, which is present as a gas at normal temperature (25° C.) and pressure (1 atm). A material in the region (3) is a gas. In this embodiment, the material in the region (3) means a high-pressure gas which has a pressure not lower than ½Pc, wherein Pc represents a critical pressure. In FIGS. 1 and 2, characters T, Pc and Tc respectively denote a triple point, a critical pressure, and a critical temperature.

Specific examples of the material for use as a compressible fluid include carbon monoxide, carbon dioxide, dinitrogen monoxide, nitrogen, methane, ethane, propane, 2,3-dimethylbutane, and ethylene. Among these materials, carbon dioxide is preferable because of having advantages such that since carbon dioxide has a relatively low critical pressure Pc (about 7.4 MPa) and a critical temperature Tc (about 31° C.) near room temperature, carbon dioxide in the supercritical state can be easily prepared; and in addition carbon dioxide is easy to handle because of being non-flammable.

These compressible fluids can be used alone or in combination.

It is described on page 173 of a document “Current Applied Technology of Supercritical Fluid” written in Japanese and published on Mar. 15, 2004 by NTS Inc. that carbon dioxide in the supercritical state cannot be used for living anion polymerization because carbon dioxide reacts with a basic material. However, the present inventors discover that a basic organic catalyst can stably coordinate with a ring-opening monomer while opening the ring, resulting in progression of the polymerization reaction in a quantitative way (i.e., progression of a living ring-opening polymerization reaction). In this regard, “living” means that a reaction proceeds in a quantitative way without a side reaction such as migration reaction and termination reaction, and the resultant polymer has a narrow molecular weight distribution (i.e., the resultant polymer is a monodisperse polymer).

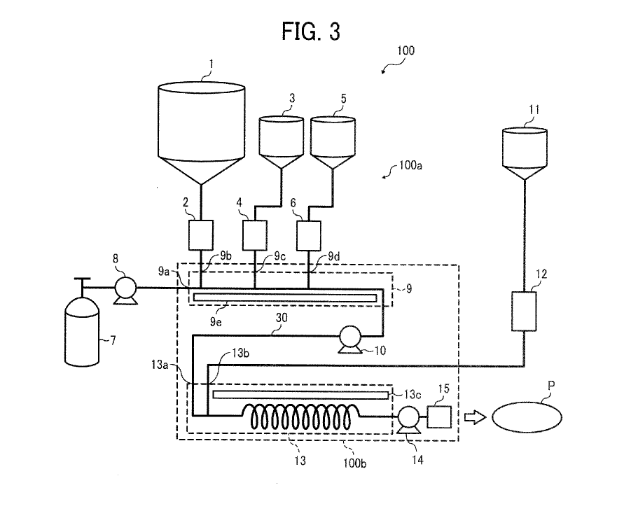

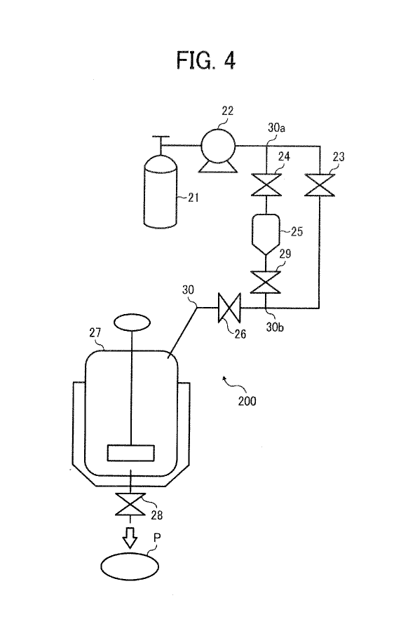

Next, the polymerization reaction apparatus for use in producing the polymer of this disclosure will be described by reference to FIGS. 3 and 4.

FIGS. 3 and 4 are schematic views illustrating polymerization systems for use in producing the polymer of this disclosure.

Initially, the polymerization reaction apparatus illustrated in FIG. 3 will be described. Referring to FIG. 3, a polymerization reaction apparatus 100 includes a supply unit 100a to supply raw materials such as a ring-opening polymerizable monomer and a compressible fluid, and a main body 100b (i.e., a continuous polymerization device) of the polymerization reaction apparatus to polymerize the ring-opening polymerizable monomer supplied by the supply unit. The supply unit 100a includes tanks 1, 3, 5, 7 and 11, measuring feeders 2 and 4, and measuring pumps 6, 8 and 12. The main body 100b includes a mixer 9 arranged at an end of the main body, a feed pump 10, a reaction container 13, a measuring pump 14, and an extrusion ring 15 which is arranged at the other end of the main body. In this embodiment, a device in which the compressible fluid and the raw materials (or resultant polymer) are mixed to dissolve or melt the raw materials is called “mixer.” In this embodiment, the term “melt” means that the raw materials (or resultant polymer) are swelled while plasticized and liquefied by being contacted with the compressible fluid. In addition, the term “dissolve” means that the raw materials are dissolved in the compressible fluid.

The tank 1 of the supply unit 100a stores the ring-opening polymerizable monomer. The ring-opening polymerizable monomer may be a powder or a liquid. The tank 3 stores solid raw materials (such as powdery raw materials and particulate raw materials) among saccharide (serving as an initiator) and additives used, and the tank 5 stores liquid raw materials among the saccharide and additives used. The tank 7 stores the compressible fluid. In this regard, the tank 7 may store a gas or a solid, which can be changed to a compressible fluid in a process of supply to the mixer 9 or by being heated or pressed in the mixer 9. In this case, the gas or solid in the tank 7, which is heated or pressed in the process of supply to the mixer or in the mixer, achieves the state (1), (2) or (3) illustrated in FIG. 2 in the mixer 9.

The measuring feeder 2 continuously supplies the ring-opening polymerizable monomer stored in the tank 1 to the mixer 9 while measuring the monomer. The measuring feeder 4 continuously supplies the solid raw material stored in the tank 3 to the mixer 9 while measuring the solid raw material. The measuring feeder 6 continuously supplies the liquid raw material stored in the tank 5 to the mixer 9 while measuring the liquid raw material. The measuring pump 8 continuously supplies the compressible fluid stored in the tank 7 to the mixer 9 at a predetermined pressure and a predetermined flow rate. In this regard, the term “continuous supply” means that the raw materials or the compressible fluid is supplied so that the polymer can be continuously produced unlike a batch polymerization reaction apparatus. Therefore, it is possible to intermittently supply the raw materials or the compressible fluid as long as the polymer can be continuously produced. In addition, when the initiator and the additives used are solid, it is possible for the polymerization reaction apparatus 100 not to have the tank 5 and the measuring pump 6. Similarly, when the initiator and the additives used are liquid, it is possible for the polymerization reaction apparatus 100 not to have the tank 3 and the measuring feeder 4.

In this embodiment, the devices of the main body 100b are connected with a pressure-resistant pipe 30 as illustrated in FIG. 3 to feed the raw materials, the compressible fluid, and the produced polymer. In addition, each of the mixer 9, the feed pump 10, and the reaction container 13 has a pipe through which the raw materials are fed.

The mixer 9 continuously contacts the raw materials such as the ring-opening polymerizable monomer, initiator and additives supplied from the tanks 1, 3 and 5 with the compressible fluid supplied from the tank 7 to dissolve or melt the raw materials. Therefore, the mixer 9 is a device having a pressure-resistant container. In the mixer 9, the raw materials are contacted with the compressible fluid, and thereby the raw materials are dissolved or melted. When the raw materials are dissolved, a fluidic phase is formed, and when the raw materials are melted, a molten phase is formed. In order that the reaction evenly proceeds, it is preferable that either the fluidic phase or the molten phase is formed. In addition, in order that the reaction proceeds under a condition such that the ratio of the raw materials to the compressible fluid is high, the ring-opening polymerizable monomer is preferably melted in the mixer 9. In this embodiment, since the raw materials and the compressible fluid are continuously supplied, the raw materials and the compressible fluid can be contacted with each other in the mixer 9 while maintaining the ratio of the raw materials to the compressible fluid at a constant level, thereby making it possible to efficiently dissolve or melt the raw materials.

The container of the mixer may be a tank type container or a cylindrical container. However, a cylindrical container in which the raw materials are supplied from one end thereof and the mixture is discharged from another end thereof is preferable. The container of the mixer 9 has an inlet 9a from which the compressible fluid in the tank 7 is supplied by the measuring pump 8, another inlet 9b from which the ring-opening polymerizable monomer in the tank 1 is supplied by the measuring feeder 2, another inlet 9c from which a powder in the tank 3 is supplied by the measuring feeder 4, and another inlet 9d from which a liquid in the tank 5 is supplied by the measuring pump 6. Each of the inlets 9a, 9b, 9c and 9d has a joint connecting the container of the mixer 9 with the pipe through which the raw materials or the compressible fluid is fed. The joint is not particularly limited, and any known joints such as reducer, coupling, Y, T, and outlet joints can be used. In addition, the mixer 9 has a heater 9e to heat the raw materials or the compressible fluid supplied. Further, the mixer 9 can have an agitator to agitate the raw materials or the compressible fluid. Specific examples of such an agitator include single screw agitators, twin screw agitators in which two screws are engaged with each other, two shaft mixers having multiple agitating members engaged or overlapping with each other, kneaders having spiral agitating members engaged with each other, and static mixers. Among these, two- or more-shaft agitators in which the agitating members are engaged with each other are preferable because the amount of the reaction product adhered to the agitators or the container is small, and the agitators have self cleaning property.

When the mixer 9 has no agitator, a pressure-resistant pipe is preferably used as the mixer. In this case, it is preferable that the pipe has a spiral form or is folded to reduce the installation space of the polymerization reaction apparatus 100 or to enhance the flexibility in layout of the apparatus. In addition, when the mixer 9 has no agitator, it is preferable that the ring-opening polymerizable monomer supplied to the mixer 9 is previously liquefied so that the materials can be well mixed in the mixer.

The feed pump 10 feeds the raw materials, which are dissolved or melted in the mixer 9 to the reaction container 13. The tank 11 stores the organic catalyst. The measuring pump 12 supplies the organic catalyst stored in the tank 11 to the reaction container 13 while measuring the organic catalyst.

The reaction container 13 is a pressure-resistant container in which the raw materials fed by the feed pump 10 and the organic catalyst supplied by the measuring pump 12 are mixed to continuously subject the ring-opening polymerizable monomer to ring-opening polymerization. The reaction container 13 can be a tank type container or a cylindrical container, but is preferably a cylindrical container because of having relatively small dead space. The reaction container 13 has an inlet 13a from which the raw materials mixed in the mixer 9 are supplied to the reaction container, and another inlet 13b from which the organic catalyst in the tank 11 is supplied by the measuring pump 12.

Each of the inlets 13a and 13b has a joint connecting the reaction container 13 with the pipe through which the raw materials are fed. The joint is not particularly limited, and any known joints such as reducer, coupling, Y, T, and outlet joints can be used. The reaction container 13 can have a gas outlet from which a vaporized material is removed. In addition, the reaction container 13 has a heater 13c to heat the raw materials supplied. Further, the reaction container 13 can have an agitator to agitate the raw materials and the compressible fluid. When the reaction container 13 has an agitator, it can be prevented that the resultant polymer precipitates in the reaction container due to the difference in density between the raw materials and the polymer, and thereby the polymerization reaction can be evenly performed in a quantitative way. Suitable agitators for use as the agitator of the reaction container 13 include agitators having screws engaged with each other, 2-flight (oval-shaped) or 3-flight (triangular shape) agitating members, and two- or more-shaft agitators having a disk-shaped or multilobar-shaped agitating blade (e.g., cloverleaf agitating blade). These agitators have good self cleaning property. When the raw materials including the catalyst are previously mixed well, a static mixer which can perform separation and confluence of flow in a multistep way using a guiding device can be used as the agitator. Specific examples of the static mixer include multi-stratification mixers disclosed in JP-S47-15526-B, JP-S47-15527-B and JP-S47-15528-B, KENICS MIXERS disclosed in JP-S47-33166-A, and other mixers having no moving member. In addition, examples of the static mixer are disclosed in U.S. Pat. Nos. 4,408,893, 5,944,419 and 5,851,067 incorporated by reference.

When the reaction container 13 has no agitator, a pressure-resistant pipe is preferably used for the reaction container. In this case, it is preferable that the pipe has a spiral form or is folded to reduce the installation space of the polymerization reaction apparatus 100 or to enhance the flexibility in layout of the apparatus.

The polymerization reaction apparatus 100 illustrated in FIG. 3 includes only one reaction container 13. However, the number of the reaction container is not limited thereto, and two or more reaction containers can be used therefor. When multiple reaction containers 13 are used, the conditions (e.g., temperature, pressure, concentration of the catalyst, average retention time, and agitation speed) of the reactions performed in the reaction containers may be the same. However, it is preferable that the conditions are changed so as to be proper depending on the progression of the reactions in the reaction containers. It is not preferable that too many reaction containers are connected because the reaction time is increased and the apparatus is complicated, and the number of the reaction containers (i.e., the number of reaction steps) is preferably from 1 to 4, and more preferably from 1 to 3.

In general, when polymerization is performed by using only one reaction container, the polymerization degree of the resultant polymer and the amount of residual monomers in the polymer tend to vary, and therefore it is considered that such a polymerization reaction apparatus cannot be used for industrial manufacturing. This is because raw materials, which typically have a melt viscosity of from few poises to tens of poises, and the resultant polymer, which typically has a melt viscosity on the order of thousands of poises, are contained while mixed in the same container.

In contrast, in this embodiment, raw materials and the resultant polymer are dissolved or melted in a compressible fluid, and therefore the viscosity difference can be decreased, thereby making it possible to reduce the number of reaction containers, i.e., to reduce the number of reaction steps, compared to conventional polymerization reaction apparatuses.

The measuring pump 14 discharges a polymer P from an outlet (the extrusion ring 15 in FIG. 3) of the reaction container 13. In this regard, it is possible to discharge the polymer P from the reaction container 13 without using the measuring pump 14 by utilizing pressure difference between the inside of the reaction container and the outside thereof. In this case, in order to adjust the pressure in the reaction container 13 and the amount of the polymer P discharged from the reaction container, a pressure control valve can be used instead of the measuring pump 14.

Next, a batch polymerization reaction apparatus 200 will be described by reference to FIG. 4.

Referring to FIG. 4, the polymerization reaction apparatus 200 includes a tank 21, a measuring pump 22, an addition pot 25, a reaction container 27, and valves 23, 24, 26, 28 and 29. These devices are connected with the pressure-resistant pipe 30. In addition, joints 30a and 30b are provided on the pipe 30.

The tank 21 stores a compressible fluid. The tank 21 can store a gas or a solid, which can be changed to a compressible fluid by being heated or pressed in a passage to the reaction container 27 or in the reaction container 27. In this case, when the gas or solid stored in the tank 21 is heated or pressed, the gas or solid achieves the state (1), (2) or (3) illustrated in FIG. 2 in the reaction container 27.

The measuring pump 22 supplies the compressible fluid stored in the tank 21 to the reaction container at a predetermined pressure and a predetermined flow rate. The addition pot 25 stores an organic catalyst to be added to the raw materials in the reaction container 27. The valves 23, 24, 26 and 29 perform switching between a passage through which the compressible fluid in the tank 21 is fed to the reaction container 27 via the addition pot 25, and a passage through which the compressible fluid in the tank 21 is fed to the reaction container 27 without passing through the addition pot 25, or the like switching.

Before starting polymerization, the ring-opening polymerizable monomer and the saccharide serving as an initiator are contained in the reaction container 27. The reaction container 27 is a pressure-resistant container in which the ring-opening polymerizable monomer and the saccharide previously contained in the container are contacted with the compressible fluid supplied from the tank 21 and the organic catalyst supplied from the addition pot 25 to subject the ring-opening polymerizable monomer to ring-opening polymerization. The reaction container 27 can have a gas outlet from which a vaporized material is removed. In addition, the reaction container 27 has a heater to heat the raw materials and the compressible fluid. Further, the reaction container 27 has an agitator to agitate the raw materials and the compressible fluid to prevent occurrence of a problem in that the resultant polymer precipitates in the reaction container due to difference in density between the raw materials and the polymer, and therefore the polymerization reaction can be evenly performed in a quantitative way. The valve 28 has a function such that when the valve is opened after the polymerization reaction is completed, the polymer P in the reaction container 27 is discharged therefrom.

Next, the method of polymerizing the ring-opening polymerizable monomer using the polymerization reaction apparatus 100, which is an example of the polymerization reaction apparatus, will be described.

Initially, the measuring feeders 2 and 4 and the measuring pumps 6 and 8 are operated to continuously supply a ring-opening polymerizable monomer (lactide), an initiator (saccharide), additives, and a compressible fluid, which are stored in the tanks 1, 3, 5 and 7, to the mixer 9 through the respective inlets 9a, 9b, 9c and 9d. In general, accuracy of measuring a solid (powdery or particulate material) is relatively low compared to accuracy of measuring a liquid. Therefore, when a solid raw material is used, it is preferable that the solid raw material is heated to a temperature higher than the melting point of the material so that the liquefied raw material is contained in the tank 5 and the liquefied raw material is then supplied to the mixer 9. The order of activation of the measuring feeders 2 and 4 and the measuring pumps 6 and 8 is not particularly limited, but it is preferable that the measuring pump 8 is initially activated because when the raw materials are fed to the reaction container 13 without being contacted with the compressible fluid, the raw materials may be solidified due to drop in temperature of the raw materials.

Since the raw materials and the compressible fluid are continuously supplied to the container of the mixer 9, the raw materials and the compressible fluid are continuously contacted with each other. Therefore, the raw materials such as a ring-opening polymerizable monomer, an initiator and additives are dissolved or melted in the compressible fluid in the mixer 9. In this regard, when the mixer has an agitator, the raw materials and the compressible fluid may be agitated. In order to prevent the supplied compressible fluid from changing to a gas, the temperature and the pressure in the reaction container 13 are controlled so as to be a temperature and a pressure not lower than those of the fluid at the triple point T illustrated in FIGS. 1 and 2. This control can be performed by adjusting the output of the heater 9e of the mixer 9 or the supplied amount of the compressible fluid. In this embodiment, it is possible that the temperature at which the ring-opening polymerizable monomer is dissolved or melted in the compressible fluid is lower than the melting point of the ring-opening polymerizable monomer at normal pressure. This is because the pressure in the mixer 9 is increased in the presence of the compressible fluid, and thereby the melting point of the ring-opening polymerizable monomer is decreased under such a high pressure condition. Therefore, even when the supplied amount of the compressible fluid is relatively small compared to the amount of the ring-opening polymerizable monomer, the ring-opening polymerizable monomer can be dissolved or melted in the mixer 9.

In order that the raw materials can be efficiently dissolve or melted, the timing of application of heat and agitation to the raw materials and the compressible fluid can be adjusted. In this regard, a method in which after the raw materials are contacted with the compressible fluid, heat and agitation are applied thereto, or a method in which the raw materials are contacted with the compressible fluid while heat and agitation are applied thereto can be used. In addition, in order to securely dissolve or melt the raw materials, a method in which after the ring-opening polymerizable monomer is heated to a temperature not lower than the melting point thereof, the ring-opening polymerizable monomer is contacted with the compressible fluid can be used. For example, when the mixer 9 is a two shaft mixer having screws, these conditions can be satisfied by adjusting arrangement of the screws, arrangement of the inlets 9a, 9b, 9c and 9d, and temperature of the heater 9e of the mixer.

In this embodiment, the additives are supplied to the mixer 9 separately from the ring-opening polymerizable monomer. However, the additives can be supplied together with the ring-opening polymerizable monomer. In addition, it is possible that after the polymerization reaction, the additives are supplied to the resultant polymer. In this regard, it is possible that after the polymer P is discharged from the reaction container 13, the additives are added to the polymer while kneading the mixture.

The raw materials dissolved or melted in the mixer 9 are fed by the feed pump 10 to the reaction container 13 through the inlet 13a. Meanwhile the organic catalyst in the tank 11 is measured and supplied by the measuring pump 12 to the reaction container 13 through the inlet 13b. Since organic catalysts can work at room temperature, in this embodiment the organic catalyst used is supplied to the reaction container 13 after the raw materials are dissolved or melted without being supplied to the mixer 9. In conventional methods of subjecting a ring-opening polymerizable monomer to ring-opening polymerization using a compressible fluid, the timing of addition of a catalyst is not considered. Since organic catalysts have high activity for ring-opening polymerization, in this embodiment the organic catalyst used is added to the reaction container 13, in which the raw materials such as the ring-opening monomer and the initiator are fully dissolved or melted in the compressible fluid. If the organic catalyst is added to raw materials which are not fully dissolved or melted, the reaction unevenly proceeds, resulting in occurrence of viscosity difference in the reaction system, thereby making it impossible to obtain a polymer having a high molecular weight.

After the raw materials fed by the feed pump 10 and the organic catalyst supplied by the measuring pump 12 are sufficiently agitated by the agitator in the reaction container 13 if desired, the raw materials and the catalyst are heated to a predetermined temperature by the heater 13c, and thereby the ring-opening polymerizable monomer is subjected to ring-open polymerization in the reaction container 13 in the presence of the organic catalyst (i.e., polymerization process). In this case, since the ring-opening polymerizable monomer is subjected to ring-open polymerization in the presence of the saccharide serving as an initiator, a polymer having a polymer chain bonded with the saccharide can be produced as the polymer P.

The lower the polymerization reaction temperature range in which the ring-opening polymerizable monomer is subjected to ring-open polymerization is not particularly limited, and is generally 40° C., preferably 50° C., and more preferably 60° C. When the polymerization reaction temperature is lower than 40° C., problems such that it takes time until the ring-opening polymerizable monomer is dissolved or melted in the compressible fluid; the ring-opening polymerizable monomer is unevenly dissolved or melted in the compressible fluid; and activity of the organic catalyst deteriorate, thereby decreasing the reaction speed or making it impossible to perform the polymerization reaction in a quantitative way tend to be caused, although whether or not the problems are caused depends on choice of the ring-opening polymerizable monomer.

The upper limit of the polymerization reaction temperature range is not particularly limited, but is generally 100° C. or a temperature which is 30° C. higher than the melting point of the ring-opening polymerizable monomer if the temperature is higher than 100′C. The upper limit is preferably 90° C. or the melting point of the ring-opening polymerizable monomer if the melting point is higher than 90° C., and more preferably 80° C. or a temperature which is 20° C. lower than the melting point of the ring-opening polymerizable monomer if the temperature is higher than 80° C.

When the polymerization reaction temperature is higher than the temperature 30° C. higher than the melting point of the ring-opening polymerizable monomer, the reverse reaction of the ring-opening reaction, i.e., depolymerization reaction, tends to be caused while the reactions are balanced, and therefore the polymerization reaction does not proceed in a quantitative way. When a ring-opening polymerizable monomer having a relatively low melting point such as a ring-opening polymerizable monomer which is liquid at room temperature is used, it is possible that the polymerization reaction temperature is higher than the temperature 30° C. higher than the melting point of the ring-opening polymerizable monomer to enhance the activity of the organic catalyst. Even in such a case, the polymerization reaction temperature is preferably not higher than 100° C. The polymerization reaction temperature can be controlled by controlling heating of the heater 13c of the reaction container 13 or by controlling external heating.

In this embodiment, the polymerization reaction time (i.e., the average retention time in the reaction container 13) is not particularly limited, and is determined based on the targeted molecular weight of the polymer P.

The pressure in the polymerization reaction, i.e., the pressure of the compressible fluid, is generally a pressure at which the compressible fluid supplied from the tank 7 becomes a liquefied gas (i.e., a Liquid in the region (2) in FIG. 2) or a pressure at which the compressible fluid supplied from the tank 7 becomes a high pressure gas (i.e., a gas in the region (3) in FIG. 2). However, the pressure is preferably a pressure at which the compressible fluid supplied from the tank 7 becomes a supercritical fluid in the region (1) in FIG. 2. When the compressible fluid achieves a supercritical state, dissolution and melting of the ring-opening polymerizable monomer can be accelerated, and thereby the polymerization reaction can be evenly performed in a quantitative way. When carbon dioxide is used as the compressible fluid, the pressure is preferably not lower than 3.7 MPa, more preferably not lower than 5 MPa, and even more preferably not lower than 7.4 MPa from the viewpoints of reaction efficiency and polymer inversion rate. In this case, the temperature is preferably not lower than 25° C. for the same reason. In this embodiment, the concentration of the compressible fluid is not particularly limited as long as the compressible fluid can dissolve or melt the raw materials and the polymer formed by the raw materials.

The amount of water in the reaction container 13 is generally not greater than 4% by mole, preferably not greater than 1% by mole, and more preferably not greater than 0.5% by mole, based on 100% by mole of the ring-opening polymerizable monomer. When the water amount is greater than 4% by mole, it becomes difficult to control the molecular weight of the polymer because water serves as an initiator. In order to control the water amount, a pretreatment such that water is removed from the ring-opening monomer and other raw materials can be performed if desired.

The polymer P formed in the reaction container 13 by the ring-opening reaction is discharged from the reaction container by the measuring pump 14. The speed of the measuring pump 14 for feeding the polymer P is preferably constant so that the pressure in the reaction container 13 filled with the compressible fluid becomes constant, and thereby the polymerization reaction is evenly performed, resulting in obtainment of a homogeneous polymer. Therefore, the liquid feeding mechanism of the reaction container 13 and the liquid feeding rate of the feed pump 10 are controlled so that the back pressure of the measuring pump 14 becomes constant. Similarly, in order that the back pressure of the feed pump 10 becomes constant, the liquid feeding mechanism of the mixer 9 and the feeding speeds of the measuring feeders 2 and 4 and the measuring pump 6 and 8 are controlled. In this regard, ON-OFF control methods (i.e., intermittent feeding methods) can be used for the control method, but continuous or step-by-step methods in which the rotation speed of the pump etc. is gradually increased or decreased are often preferably used. By using such control methods, a homogeneous polymer can be stably produced.

The thus obtained polymer P is optionally subjected to a treatment in which the organic catalyst remaining in the polymer is removed therefrom so that the content of the organic catalyst remaining in the polymer is less than 2% by weight. The method of removing the residual organic catalyst is not particularly limited, and specific examples thereof include distillation methods under reduced pressure (when the organic catalyst is a compound having a boiling point), extraction methods in which a material capable of dissolving the organic catalyst is used as an entrainer to remove the organic catalyst, and absorption methods in which the organic catalyst is absorbed by a column. In this regard, the method of removing the residual organic catalyst may be a batch method in which the organic catalyst is removed from the polymer after the polymer is discharged from the reaction container, or a continuous method in which the organic catalyst is removed from the polymer without discharging the polymer from the reaction container. When the distillation methods under reduced pressure are used, the condition of the reduced pressure is determined based on the boiling point of the organic catalyst. For example, since the temperature in the pressure reduction process is from 100° C. to 120° C., it is possible that the organic catalyst can be removed at a temperature lower than the depolymerization temperature of the polymer. When an organic solvent is used for extraction of the organic catalyst, it often becomes necessary to perform a process of removing the organic solvent. Therefore, it is preferable to use the compressible fluid as the solvent for the extraction. Any known technologies of extracting perfume can be used for the extraction.

In this embodiment, the polymer of this disclosure can be obtained by subjecting a ring-opening polymerizable monomer to ring-opening polymerization using a compressible fluid, an organic catalyst including no metal atom, and a saccharide serving as an initiator, and has a polymer chain bonded with the saccharide. In this case, since a compressible fluid is used, the polymerization reaction can be performed at a relatively low temperature. Therefore, chance of occurrence of depolymerization can be dramatically reduced compared to a case using, a conventional melt polymerization method. Therefore, the amount of the residual ring-opening polymerizable monomer in the polymer can be reduced so as to be not greater than 0.1% by weight (1,000 ppm). It is possible to reduce the amount of the residual ring-opening polymerizable monomer so as to be not greater than 300 ppm (preferable level), and not greater than 100 ppm (more preferable level). In this regard, the amount of the residual ring-opening polymerizable monomer is a mass fraction represented by the following equation:

Mass fraction=Mr/Mt,

wherein Mr represents the mass of the residual ring-opening polymerizable monomer, and Mt represents the total mass of the ring-opening polymerizable monomer, which is equal to the total of the mass of the polymer and the mass of the residual ring-opening polymerizable monomer. The amount of the residual ring-opening polymerizable monomer can be determined by the method described in Part 3, Hygienic Test Method, in the third revised version of “Voluntary Standards concerning Food Container and Package of Synthetic Resin such as Polyolefin” written in Japanese and published in June 2004.

When the amount of the residual ring-opening polymerizable monomer in the polymer is greater than 1,000 ppm, the thermal property of the polymer deteriorates, thereby deteriorating the heat stability of the polymer. In addition, since a carboxylic acid formed in the ring-opening process of the residual ring-opening polymerizable monomer has a catalytic function of accelerating hydrolysis, the polymer tends to be easily decomposed. The amount of the residual ring-opening polymerizable monomer in the polymer obtained in this embodiment is little, the polymer has dramatically-improved stability. In this embodiment, by properly setting the polymerization reaction conditions as mentioned above, the amount of the residual ring-opening polymerizable monomer can be controlled so as to be not higher than 1,000 ppm.

The number average molecular weight of the polymer of this embodiment is adjustable and is determined based on the purpose of the polymer, but is generally not less than 2,000, preferably not less than 5,000, and more preferably not less than 7,000. The number average molecular weight is preferably not greater than 200,000, and more preferably not greater than 100,000. For example, when the polymer is used for DDS (drug delivery system), the number average molecular weight of the polymer is preferably from 5,000 to 50,000, and when the polymer is used for structural materials, the number average molecular weight of polymer is preferably from 50,000 to 200,000. However, the number average molecular weight of the polymer is not limited thereto. In this regard, the number average molecular weight of the polymer is determined by GPC (gel permeation chromatography). When the number average molecular weight of the polymer is less than 2,000, the polymer becomes brittle, and therefore the application of the polymer is limited. The ratio (Mw/Mn) of the weight average molecular weight (Mw) of the polymer to the number average molecular weight (Mn) thereof is preferably from 1.2 to 2.5, more preferably from 1.2 to 2.0, and even more preferably from 1.2 to 1.5. When the ratio (Mw/Mn) is greater than 2.5, the amount of low molecular weight components increases, and therefore the polymer tends to be easily decomposed.

Since the polymer of this embodiment is produced without using a metallic catalyst and an organic solvent, the polymer does not substantially include a metal atom and an organic solvent. In addition, since the amount of the residual monomer in the polymer is not greater than 0.1% by weight (1000 ppm), the polymer has a good combination of safety and stability. Therefore, particles of the polymer of this disclosure can be broadly used for various purposes such as articles for daily use, medicines, cosmetics, and electrophotographic toner. In this regard, metallic catalysts mean catalysts used for ring-opening polymerization and including a metal. In addition, the passage “the polymer does not substantially include a metal atom” means that the polymer does not include a metal atom derived from a metallic catalyst. Specifically, the passage means that when the polymer is analyzed by a known method such as inductively coupled plasma emission spectroscopy (ICPES), atomic absorption analysis, and colorimetric method to detect a metal atom derived from a metallic catalyst in the polymer, the metal atom is not detected (i.e., the amount of metal atom is less than the detection limit of the method).

In this regard, the metallic catalyst is not particularly limited, and specific examples thereof include tin compounds such as tin octylate, tin dibutyrate, and tin di(2-ethylhexanoate); aluminum compounds such as aluminum acetylacetonate, and aluminum acetate; titanium compounds such as tetraisopropyl titanate, and tetrabutyl titanate; zirconium compounds such as zirconium isopropoxide; and antimony compounds such as antimony trioxide. Specific examples of the metal atoms derived from metallic catalysts include atoms of tin, aluminum, titanium, zirconium and antimony.

The above-mentioned organic solvent means solvents of organic materials which can dissolve the polymer. When the polymer obtained by the ring-opening polymerization reaction includes a polylactic acid chain, specific examples of the organic solvent include halogen solvents such as chloroform and methylene chloride, and tetrahydrofuran. The passage “the polymer does not substantially include an organic solvent” means that the content of the organic solvent in the polymer is less than the detection limit.

The method of measuring an organic solvent remaining in the polymer is as follows. Specifically, 1 part of the polymer is mixed with 2 parts of 2-propanol, and the mixture was subjected to an ultrasonic dispersing treatment for 30 minutes. The mixture is allowed to settle in a refrigerator (5° C.) for 1 day or more to extract an organic solvent included in the polymer. The supernatant of the mixture is analyzed by gas chromatography to determine the amount of the organic solvent. In this regard, the measurement conditions are the following.

Instrument used: GC-14A from Shimadzu Corp.

Column used: CBP20-M 50-0.25

Detector: FID

Injected amount: 1 to 5 μl

Carrier gas: He (2.5 kg/cm²)

Flow rate of hydrogen: 0.6 kg/cm²

Flow rate of air: 0.5 kg/cm²

Chart speed: 5 mm/min

Sensitivity: Range101×Atten20

Column temperature: 40° C.

Injection Temp.: 150° C.

Since the polymer produced by the above-mentioned method includes a relatively small amount of residual ring-opening polymerizable monomer, and the reaction temperature is very low, occurrence of a problem in that the polymer is colored yellow can be prevented, and the polymer is colored white. In this regard, the degree of yellowing of a polymer can be measured by the following method.

(1) A pellet of the polymer having a thickness of 2 mm is prepared; and
(2) The YI value of the pellet is measured by the method described in JIS-K7103 using an instrument, SM COLOR COMPUTER from Suga Test Instruments Co., Ltd.

In this regard, when the YI value of the polymer is not greater than 5, it can be said that the polymer is colored white.

Next, the clathrate of this disclosure will be described.

The clathrate of this disclosure has a configuration such that the saccharide included in the polymer of this disclosure incorporates another material (i.e., a material to be contained therein). Specific examples of such a material to be contained in saccharide include, but are not limited thereto, polymers and oligomers such as polyethylene glycol, polypropylene glycol, and polymethyl vinyl ether; fluorescent dyes, perfumes, medicines, functional compounds such as refreshers, antiseptics and fungicides, and molecules such as iodine molecules. The material to be contained in the clathrate is changed depending on the purpose of the clathrate. For example, in clathrate used for forming a micelle for use in drug delivery system (DDS), a hydrophobic polymer is bonded with the saccharide of the clathrate. In this regard, in order to form a micelle, a block copolymer of a hydrophobic polymer and a hydrophilic polymer is necessary, and therefore a polyethylene glycol compound, which is a hydrophilic polymer and is non-toxic, is preferably used as the material to be contained in the clathrate.

The method of producing a clathrate of this disclosure is not particularly limited as long as the clathrate uses the polymer of this disclosure. For example, a method in which the polymer of this disclosure and a material to be contained are mixed while dispersing or dissolving the material can be used. In addition, a method in which after a material to be contained such as a functional compound is contained in a saccharide serving as an initiator, the saccharide containing the material is bonded with the polymer chain when the polymer of this disclosure is prepared can also be used. Further, a method in which the polymer of this disclosure is subjected to aggregation or higher-order structuring to incorporate a functional compound therein can also be used.

The clathrate of this disclosure is preferably used for articles for daily use such as drinks, foods, cosmetics, and refreshers/antiseptics/fungicides, and medicines for DDS such as regeneration medicines for bone and body and medicines for gene remedy and cancer treatment, but the application is not limited thereto.

Next, the sheet and the aqueous dispersion of this disclosure will be described.

In order to stably disperse a sheet, which is formed by a hydrophobic polymer such as polylactic acid, in water, a method in which a dispersant such as surfactants is added thereto has been conventionally used. In such a ease, the dispersion can be used for body only when the dispersant is safe for body. Namely, application of the dispersion is limited. In addition, when a sheet of such a polymer is used for trauma care, the curative effect tends to deteriorate if the aqueous dispersion of the sheet includes a dispersant. When a hydrophilic polymer or oligomer is incorporated at the end of such a hydrophobic polymer or is copolymerized with such a hydrophobic polymer to enhance the water dispersibility of the hydrophobic polymer, a problem such that the resultant sheet does not satisfy the requirement of the sheet or is not biocompatible is often caused.

The polymer of this disclosure can have a sheet form. In addition, the aqueous dispersion of this disclosure includes the sheet of the polymer of this disclosure and water, wherein the sheet is dispersed in water.

Since the polymer constituting the sheet (such as nano-sheet) has a configuration such that a saccharide such as cyclodextrin is incorporated in the polymer chain such as polylactic acid, the sheet has good water dispersibility because the saccharide has good hydrophilicity. Therefore, even when a dispersant such as surfactants is not used, the sheet can be easily dispersed in water, and therefore the sheet has good biocompatibility.

The method of preparing the sheet and the aqueous dispersion of this disclosure is not particularly limited, and any known methods of preparing a sheet and an aqueous dispersion can be used except that the polymer of this disclosure is used therefor. One method of preparing the sheet of this disclosure is that a polymer in which a polymer such as polylactic acid and a saccharide such as cyclodextrin are bonded to each other is dissolved in a solvent such as methylene chloride; and the solution is applied on a film of resin such as polyvinyl alcohol. One method of preparing the aqueous dispersion of this disclosure is that the above-prepared resin film bearing the sheet of this disclosure is dipped into water to release the sheet from the resin film. The thickness of the sheet is not particularly limited, but is generally from 0.01 μm to 100 μm, and preferably from 0.02 μm to 50 μm.

Application of the sheet and the aqueous dispersion of this disclosure is not particularly limited, but the sheet and the aqueous dispersion are preferably used for wound care medicines and skin care medicines. In addition, the sheet of this disclosure can be used as a scaffolding sheet for cell culturing.

The polymer of this disclosure is prepared by subjecting a ring-opening polymerizable monomer to ring-opening polymerization using a compressible fluid, an organic catalyst including no metal atom, and a saccharide serving as an initiator, and has a polymer chain bonded with the saccharide. The resultant polymer does not substantially include an organic solvent and a metal atom, and the amount of the residual ring-opening polymerizable monomer in the polymer is not greater than 0.1% by weight (i.e., 1,000 ppm). Since the polymer can be prepared without using an organic solvent and the amount of the residual ring-opening polymerizable monomer in the polymer is relatively small, occurrence of problems such that safety and stability of the polymer deteriorate due to such organic solvent and residual monomer can be prevented.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The below-mentioned polymers of Examples and Comparative Examples were evaluated with respect to the following properties.

### 1. Molecular Weight of the Polymer

The number average molecular weight (Mn) and the weight average molecular weight (Mw) of the polymers were measured by gel permeation chromatography (GPC) under the following conditions.

Instrument used: GPC-8020 from TOSOH CORPORATION

Column used: TSK G2000HXL and G4000HXL from TOSOH CORPORATION

Temperature: 40° C.

Solvent: Chloroform

Flow rate: 1.0 ml/min

Specifically, 1 ml of a 0.5% by weight solution of a sample (polymer) was injected to the instrument to obtain the molecular weight distribution of the polymer. The number average molecular weight (Mn) and the weight average molecular weight (Mw) of the polymer were calculated using the molecular weight distribution and a molecular weight calibration curve previously prepared using mono-disperse polystyrene standard samples. In addition, the molecular weight distribution (Mw/Mn) of the polymer was also calculated.

### 2. Amount of Residual Ring-Opening Polymerizable Monomer in the Polymer

The amount of the residual ring-opening polymerizable monomer in the polymer was determined by the method of determining the amount of lactide, which is described in Part 3, Hygienic Test Method, in the third revised version of “Voluntary Standards concerning Food Container and Package of Synthetic Resin such as Polyolefin” published in June 2004. Specifically, a sample (polymer having a polylactic acid chain) was evenly dissolved in dichloromethane, and a mixture of acetone and cyclohexane was added thereto to precipitate the polymer. The supernatant was subjected to gas chromatography with hydrogen flame ionization detector (FID) to separate the ring-opening polymerizable monomer (i.e., lactide), and the amount of the residual ring-opening polymerizable monomer was determined by an internal reference method. The conditions of gas chromatography were as follows.

Column used: Capillary column (e.g., DB-17MS from J & W having a length of 30 m, an inner diameter of 0.25 mm, and a thickness of 0.25 μm)

Internal reference: 2,6-Dimethyl-γ-pyrone

Column flow rate: 1.8 ml/min

Column temperature: After the column temperature was maintained at 50° C. for 1 minute, the column temperature was raised at a constant speed of 25° C./min, and the column temperature was maintained at 320° C. for 5 minutes.

Detector: Hydrogen flame ionization detector (FED)

In Tables 1 and 2 below, ppm represents mass fraction.

### 3. Amount of Residual Catalyst in the Polymer

The amount of the residual catalyst (Arc) in the polymer was calculated from the following equation.

Arc=Ap−Am,

wherein Ap represents the area of a peak (% by weight) of components having a molecular weight of not greater than 1,000, which was determined by the GPC mentioned above in paragraph 1, and Am represents the amount (% by weight) of the residual ring-opening polymerizable monomer determined by the GC mentioned above in paragraph 2.

### 4. Amount of Metal in the Polymer

When a metal (metallic catalyst) was used for producing the polymer, the amount (% by weight) of the metal in the polymer was determined by an ICP (Inductively Coupled Plasma) method. In this case, after the polymer was weighed, the polymer was subjected to wet decomposition using sulfuric acid and hydrogen peroxide, and then subjected to an ICP (Inductively Coupled Plasma) metal analysis using an ICP-AES apparatus (JY-138U from JOBIN YVON) to determine whether or not the polymer includes the metal atom derived from the catalyst.

The below-mentioned polymers of Examples 1-10 and Comparative Example 1 were prepared by using the polymerization reaction apparatus 200 illustrated in FIG. 4. A carbon dioxide tank was used as the tank 21 of the polymerization reaction apparatus 200, and a 100 ml batch pressure container was used as the reaction container 27 of the polymerization reaction apparatus 200. The polymer of Comparative Example 2 was prepared using the polymerization reaction apparatus 200 used for preparing the polymer of Example 1 except that a nitrogen tank was used instead of the carbon dioxide tank.

### Example 1

The lactide of L-lactic acid was used as the monomer, and w-cyclodextrin was used as the initiator. The monomer (M) and the initiator (I) were fed into the reaction container 27 with a volume of 100 ml at a molar ratio (Mil) of 100/0.3, wherein the total weight of the monomer and the initiator was 50 g. After the mixture was heated to 110° C., supercritical carbon dioxide (having a temperature of 60° C. and a pressure of 12 MPa) serving as the compressible fluid was fed into the reaction container 27 by the measuring pump 22, and the re was agitated for 10 minutes to melt the raw materials (i.e., the monomer and initiator). After the temperature of the reaction system was controlled at 60° C., the passage of the compressible fluid was switched to a passage via the addition pot 25 to feed the organic catalyst (1,8-diazabicyclo[5.4.0]undec-7-ene (DBU), 0.5 mol %) in the addition pot to the reaction container 27 at a pressure 1 MPa higher than the pressure in the reaction container. The mixture was reacted for 2 hours. After the reaction, the reaction product was discharged through the valve 28 while reducing the pressure. In this case, since carbon dioxide was vaporized, the polymer, which is a polylactic acid bonded with the saccharide, was obtained. The properties of the polymer, which were measured by the methods mentioned above, are described in Tables 1 and 2 below.

The abbreviations in Tables 1 and 2 represent the following compounds.

L-Lac: Lactide of L-lactic acid

D-Lac: Lactide of D-lactic acid

γ-BLC: γ-Butyrolactone

δ-VLC: δ-Valerolactone

ε-CPL: ε-Caprolactone

α-CD: α-Cyclodextrin

β-CD: β-Cyclodextrin

γ-CD: γ-Cyclodextrin

DBU: 1,8-Diazabicyclo[5.4.0]undec-7-ene

DMAP: N,N-Dimethyl-4-aminopyridine

SnOcA: Tin di(2-ethylhexanoate)

### Examples 2-10

The procedure for preparation and evaluation of the polymer in Example 1 was repeated except that the monomer, the initiator, the catalyst, and the amount of the catalyst were changed as described in Tables 1 and 2 to prepare polymers of Examples 2-10. The properties of the polymers are described in Tables 1 and 2 below.

Since the polymers of Examples 1-10 were prepared by a method using no organic solvent, the polymer did not substantially include an organic solvent. In addition, since the polymers of Examples 1-10 were prepared by a method using no metallic catalyst, the polymer did not substantially include a metal.

### Comparative Example 1

The procedure for preparation and evaluation of the polymer in Example 1 was repeated except that tin di(2-ethylhexanoate) was used as the catalyst to prepare a polymer of Comparative Example 1. The properties of the polymer of Comparative Example 1 are described in Table 2 below.

### Comparative Example 2

The procedure for preparation and evaluation of the polymer in Example 1 was repeated except that tin di(2-ethylhexanoate) was used as the catalyst, and the reaction was performed at 190° C. and normal pressure (under a pressure of 0.1 MPa using a nitrogen gas) without using supercritical carbon dioxide to prepare a polymer of Comparative Example 2. The properties of the polymer of Comparative Example 2 are described in Table 2 below.

TABLE 1

| | Example | | | | | |
|---|---|---|---|---|---|---|
| | 1 | 2 | 3 | 4 | 5 | 6 |
| Monomer | L-Lac | D-Lac | D-Lac/L-Lac | L-Lac | L-Lac | γ-BLC |
| Added | 100 | 100 | 80/20 | 100 | 100 | 100 |
| amount of | | | | | | |
| monomer | | | | | | |
| Initiator | α-CD | α-CD | α-CD | α-CD | α-CD | α-CD |
| Added | 0.3 | 0.3 | 1.0 | 0.2 | 0.5 | 0.3 |
| amount of | | | | | | |
| initiator | | | | | | |
| Catalyst | DBU | DBU | DBU | DBU | DMAP | DMAP |
| Added | 0.5 | 0.3 | 1.8 | 0.6 | 1.0 | 1.0 |
| amount of | | | | | | |
| catalyst | | | | | | |
| Pressure | 12 | 12 | 12 | 12 | 12 | 12 |
| (MPa) | | | | | | |
| Temperature | 60 | 60 | 60 | 60 | 60 | 60 |
| (° C.) | | | | | | |
| Reaction | 2 | 2 | 2 | 2 | 2 | 2 |
| time (hr) | | | | | | |
| Mn | 47,600 | 47,400 | 15,200 | 72,500 | 29,400 | 28,510 |
| Amount of | 160 | 180 | 100 | 200 | 120 | 130 |
| residual | | | | | | |
| monomer | | | | | | |
| (ppm) | | | | | | |
| Amount of | 0.50 | 0.30 | 1.86 | 0.60 | 0.84 | 1.40 |
| residual | | | | | | |
| catalyst (% | | | | | | |
| by mole) | | | | | | |
| Amount of | 0 | 0 | 0 | 0 | 0 | 0 |
| residual | | | | | | |
| metal (% | | | | | | |
| by mole) | | | | | | |

Added amount of monomer: Added amount (parts by weight) of the monomer
Added amount of initiator: Added amount (% by mole) of the initiator based on the amount of the monomer
Added amount of catalyst: Added amount (% by mole) of the catalyst based on the amount of the monomer

TABLE 2

| | Example | | | | Comparative Example | |
|---|---|---|---|---|---|---|
| | 7 | 8 | 9 | 10 | 1 | 2 |
| Monomer | δ-VLC | L-Lac/γ-BLC | L-Lac | ε-CPL | L-Lac | L-Lac |
| Added | 100 | 50/50 | 100 | 100 | 100 | 100 |
| amount of | | | | | | |
| monomer | | | | | | |
| Initiator | β-CD | α-CD | γ-CD | α-CD | α-CD | α-CD |
| Added | 0.5 | 0.3 | 0.3 | 0.3 | 0.3 | 0.3 |
| amount of | | | | | | |
| initiator | | | | | | |
| Catalyst | DMAP | DBU | DBU | DBU | SnOcA | SnOcA |
| Added | 1 | 1 | 0.6 | 1 | 0.5 | 0.5 |
| amount of | | | | | | |
| catalyst | | | | | | |
| Pressure | 12 | 12 | 12 | 12 | 12 | 0.1 (N₂) |
| (MPa) | | | | | | |
| Temperature | 60 | 60 | 60 | 60 | 60 | 190 |
| (° C.) | | | | | | |
| Reaction | 2 | 2 | 2 | 2 | 2 | 2 |
| time (hr) | | | | | | |
| Mn | 20,200 | 31,220 | 48,300 | 37,540 | 58,000 | 23,400 |
| Amount of | 120 | 200 | 220 | 400 | 5,000 | 8,800 |
| residual | | | | | | |
| monomer | | | | | | |
| (ppm) | | | | | | |
| Amount of | 1.20 | 1.61 | 0.60 | 1.10 | 1.41 | 1.41 |
| residual | | | | | | |
| catalyst (% | | | | | | |
| by mole) | | | | | | |
| Amount of | 0 | 0 | 0 | 0 | 0.41 | 0.41 |
| residual | | | | | | |
| metal (% | | | | | | |
| by mole) | | | | | | |

### Examples 11-15

In dimethylformamide (DMF), each of the polymers of Examples 1, 3, 7 and 8 was mixed with a material to be contained in the polymer described in Table 3 below while agitated to prepare compounds.

### Comparative Example 3

The procedure for preparation of the compound in Example 11 was repeated except that the polymer was changed as described in Table 3 below to prepare a compound.

The molecular weight of the compounds was measured to determine whether or not a clathrate is formed. Whether or not a clathrate is formed was determined as follows.

◯: A clathrate was formed (the molecular weight of the compound was higher than that of the polymer).
X: A clathrate was not formed (the molecular weight of the compound was not higher than that of the polymer).

TABLE 3

| | | | | | | Comparative |
|---|---|---|---|---|---|---|
| | Example | | | | | Example |
| | 11 | 12 | 13 | 14 | 15 | 3 |
| Polymer | Polymer of | Polymer of | Polymer of | Polymer of | Polymer of | RESOMER |
| | Ex. 1 | Ex. 1 | Ex. 3 | Ex. 7 | Ex. 8 | R 203S |
| Amount of | 20 | 20 | 20 | 20 | 20 | 20 |
| polymer | | | | | | |
| (g) | | | | | | |
| Compound | PEG 1000 | DMPEG | PEG 1000 | PPG-PEG | DMPEG | PEG 1000 |
| to be | | 2000 | | | 2000 | |
| contained | | | | | | |
| Amount of | 0.82 | 1.62 | 2.60 | 4.16 | 1.08 | 0.82 |
| compound | | | | | | |
| (g) | | | | | | |
| Formation | ◯ | ◯ | ◯ | ◯ | ◯ | X |
| of clathrate | | | | | | |

PEG 1000: Polyethylene glycol having a molecular weight of 1,000
DMPEG 2000: Polyethylene glycol dimethyl ether having a molecular weight of 2,000
PPG-PEG: Polyethylene glycol-polypropylene glycol block copolymer having a molecular weight of 4,400 (PLURONIC L121 from BASF Ltd.)
RESOMER R 203S: Poly(D,L-lactide) having a molecular weight of from 18,000 to 28,000 (Product No. 719935 from Sigma-Aldrich Co.)

### Polymer Production Example 1

The following components were fed into the reaction container 27 having a volume of 100 ml so that the mixture has a weight of 50 g.

| | |
|---|---|
| Lactide of L-lactic acid serving as a monomer | 28.8 parts |
| α-Cyclodextrin serving as an initiator | 3.891 parts |

After the mixture was heated to 110° C., supercritical carbon dioxide (having a temperature of 60° C. and a pressure of 12 MPa) serving as the compressible fluid was fed into the reaction container 27 by the measuring pump 22, and the mixture was agitated for 10 minutes to melt the raw materials (i.e., the monomer and initiator). After the temperature of the reaction system was controlled at 60° C., the passage of the compressible fluid was switched to a passage via the addition pot 25 to feed the organic catalyst (1,8-diazabicyclo[5.4.0]undec-7-ene (DBU), 0.5 mol %) in the addition pot to the reaction container 27 at a pressure 1 MPa higher than the pressure in the reaction container. The mixture was reacted for 2 hours. After the reaction, the reaction product was discharged through the valve 28 while reducing the pressure. In this case, since carbon dioxide was vaporized, a polymer P-1 was obtained.

The weight average molecular weight (Mw) of the polymer P-1, which was measured by the method mentioned above, is described in Table 4 below.

### Polymer Production Examples 2-10

The procedure for preparation of the polymer in Polymer Production Example 1 was repeated except that the monomer and the initiator were changed as described in Tables 4 and 5 below. The weight average molecular weights (Mw) of the polymers P-2 to P-10 are described in Table 4 below.

TABLE 4

| | Formulation (parts by weight) | | | | | | | | |
|---|---|---|---|---|---|---|---|---|---|
| | | | M- | ε- | | | | | Mw |
| | L-LT | D-LT | LT | CLP | α-CD | β-CD | γ-CD | LA | (×10³) |
| P-1 | 28.8 | | | | 3.891 | | | | 8.2 |
| P-2 | 28.8 | | | | 0.486 | | | | 58.6 |
| P-3 | 28.8 | | | | 0.195 | | | | 142.0 |
| P-4 | 28.8 | | | | 0.146 | | | | 188.0 |
| P-5 | | 28.8 | | | 0.146 | | | | 190.2 |
| P-6 | 24.5 | 4.32 | | | 0.117 | | | | 201.5 |
| P-7 | 21.6 | | 7.21 | | | 0.227 | | | 110.2 |
| P-8 | 21.6 | | | 5.71 | 0.195 | | | | 106.8 |
| P-9 | 28.8 | | | | 0.146 | | 0.065 | | 195.3 |
| P-10 | 28.8 | | | | | | | 0.037 | 150.5 |

The abbreviations in Table 4 represent the compounds described in Table 5 below.

TABLE 5

| Abbreviations | Compounds | Formula weight (g/mol) |
|---|---|---|
| L-LT | L-lactide | 144.1 |
| D-LT | D-lactide | 144.1 |
| M-LT | Meso-lactide | 144.1 |
| ε-CLP | ε-caprolactone | 114.1 |
| α-CD | α-cyclodextrin | 972.8 |
| β-CD | β-cyclodextrin | 1135.0 |
| γ-CD | γ-cyclodextrin | 1297.1 |
| LA | Lauryl alcohol | 186.3 |

### Example 2-1

A solution of polyvinyl alcohol (KURARAY POVAL PVA217 from KURARAY Co., Ltd.) was applied on a glass plate of 10 cm×10 cm by a spin coating method, followed by drying to prepare a polyvinyl alcohol (PVA) film. Next, 60 parts of the polymer P-1 and 40 parts of the polymer P-10 were dissolved in methylene chloride to prepare a solution having a solid content of 5% by weight. The solution was applied on the PVA film, followed by drying to prepare a polymer film including the polymers P-1 and P-10 on the PVA film to prepare a combined film). The combined film was cut to prepare sheets having a size of 1 cm×1 cm. The sheets of the combined film were dipped into water to release the sheets of the polymer film from the PVA film (i.e., to obtain the sheets of the polymer film). The sheets of the polymer film were dispersed for 60 seconds in 200 ml of ion-exchange water using a HOMOMIXER mixer (MARK II type 2.5 from PRIMIX Corporation), which was rotated at a revolution of 10,000 rpm. The size (Dv) of pieces of the polymer film sheets in the dispersion was determined by a particle diameter distribution measuring instrument, MULTISIZER 4 from Beckman Coulter Inc. with an aperture of 1,000 μm.

The formula of the sheet and the size (Dv) of pieces of the polymer film sheets are described in Table 6 below.

### Examples 2-2 to 2-10 and Comparative Example 2-1 and 2-2

The procedure for preparation of the aqueous dispersion of the sheet in Example 2-1 was repeated except that the polymer, additive, and the added amount thereof were changed as described in Table 6 to prepare aqueous dispersions of polymer film sheets.

The size (Dv) of polymer film sheets in the aqueous dispersions is described in Table 6 below.

TABLE 6

| | Polymer used for preparing the | | | Additive | Size (Dv) of |
|---|---|---|---|---|---|
| | polymer sheet (parts by weight) | | | (parts by | pieces of |
| | Polymer 1 | Polymer 2 | Polymer 3 | weight) | sheet (μm) |
| Ex. 2-1 | P-1 (60) | P-10 (40) | | No | 50 |
| Ex. 2-2 | P-1 (40) | P-4 (40) | P-10 (20) | No | 75 |
| Ex. 2-3 | P-2 (100) | | | No | 55 |
| Ex. 2-4 | P-3 (100) | | | No | 120 |
| Ex. 2-5 | P-4 (100) | | | No | 165 |
| Ex. 2-6 | P-5 (100) | | | No | 240 |
| Ex. 2-7 | P-6 (100) | | | No | 305 |
| Ex. 2-8 | P-7 (100) | | | No | 180 |
| Ex. 2-9 | P-8 (100) | | | No | 190 |
| Ex. 2-10 | P-9 (100) | | | No | 172 |
| Comp. Ex. | P-10 (100) | | | No | >800 (the |
| 2-1 | | | | | dispersion |
| | | | | | included |
| | | | | | many |
| | | | | | aggregates) |
| Comp. Ex. | P-10 (98) | | | Sodium | 720 (the |
| 2-2 | | | | dodecyl | dispersion |
| | | | | sulfate (2) | partially |
| | | | | | aggregated) |

As mentioned above, the polymer of this disclosure is prepared by subjecting a ring-opening polymerizable monomer to ring-opening polymerization using a compressible fluid, art organic catalyst including no metal atom, and a saccharide serving as an initiator, and has a polymer chain bonded with the saccharide. The polymer can produce effects such that the polymer does not substantially include an organic solvent and a metal atom, and the amount of residual ring-opening monomer in the polymer is not greater than 0.1% by weight (i.e., 1,000 ppm). Since the polymer can be prepared without using an organic solvent and the amount of residual ring-opening monomer in the polymer is relatively small compared to the amount of residual ring-opening monomer in a polymer prepared by a conventional method in which raw materials are heated for a long period of time at a high temperature, occurrence of problems such that safety and stability of the polymer deteriorate due to such organic solvent and residual monomer can be prevented.

Additional modifications and variations of the present invention are possible in light of the above teachings. It is therefore to be understood that within the scope of the appended claims the invention may be practiced other than as specifically described herein,

What is claimed is:

1. A polymer comprising:
a polymer chain, and
a saccharide bonded with the polymer chain,
wherein the polymer does not substantially include an organic solvent and a metal atom, and includes a residual monomer in an amount of not greater than 1,000 ppm.

2. The polymer according to claim 1, containing another material therein in such a manner that the polymer serves as a clathrate.

3. The polymer according to claim 1, wherein the saccharide is a cyclic oligosaccharide.

4. The polymer according to claim 3, wherein the cyclic oligosaccharide is cyclodextrin or a cyclodextrin derivative.

5. The polymer according to claim herein the polymer has a number average molecular weight of not less than 2,000.

6. The polymer according to claim 1, wherein the polymer chain includes a carbonyl bond.

7. The polymer according to claim 6, wherein the polymer chain includes an ester bond or a carbonate bond.

8. The polymer according to claim 7, wherein the polymer chain includes a polyester chain or a polycarbonate chain.

9. The polymer according to claim 1, wherein the polymer is prepared by subjecting a ring-opening polymerizable monomer to ring-opening polymerization using a compressible fluid, an organic catalyst including no metal atom, and the saccharide which serves as an initiator.

10. The polymer according to claim 1, wherein the polymer has a sheet form.

11. A clathrate comprising:
the polymer according to claim 1; and
another material contained in the polymer in such a manner that an ion, an atom or a molecule of the material is contained in a void formed by a molecule or an aggregate of the polymer.

12. An aqueous dispersion comprising:
water; and
the polymer according claim 10, wherein the polymer having a sheet form is dispersed in water.
